(19) United States
(12) Patent Application Publication
(10) Pub. No.: US 2015/0002948 A1
(43) Pub. Date: Jan. 1, 2015

(54) Magnification Viewer Lens

(71) Applicant: Cleveland Darrell Mitchell, Toano, VA (US)

(72) Inventor: Cleveland Darrell Mitchell, Toano, VA (US)

(21) Appl. No.: 14/320,928

(22) Filed: Jul. 1, 2014

Related U.S. Application Data
(60) Provisional application No. 61/841,680, filed on Jul. 1, 2013.

(51) Int. Cl. G02B 7/02; G02B 7/14

(52) U.S. Cl. CPC G02B 7/02; G02B 7/14
USPC 359/818

(57) ABSTRACT

A magnification lens holder is provided for use with a golf cart steering column or for general use while shopping in a grocery store. The preferred embodiment comprises a magnifying viewer lens disposed within a housing that allows the lens to be removed and interchanged. A support assembly is provided having one or more ball joints and a clamp assembly for securing the same to the steering column of a golf cart. The viewer lens is positionable over or through the steering wheel of the cart to magnify a score card, whereby the viewer lens rotates with the steering column while driving. An alternate configuration is contemplated for supporting the viewer lens from a shopping cart or basket, providing the user with a magnifying lens while shopping and inspecting grocery items. The viewer lens housing is removable from the support assembly in both embodiments.

### CROSS REFERENCE TO RELATED APPLICATION

This application claims the benefit of U.S. Provisional Application No. 61/841,680 filed on Jul. 1, 2013, entitled “Golf Cart Magnification Screen for Scorecard.” The above identified patent application is herein incorporated by reference in its entirety to provide continuity of disclosure.

### BACKGROUND OF THE INVENTION

1. Field of the Invention

The present invention relates to magnification viewers and to scorecard holders. More specifically, the present invention relates to a scorecard holder with a magnification lens for improving the user's ability to read the scorecard, and further for providing an assembly attachable to a golf cart steering wheel column. Another embodiment contemplates an assembly attachable to a grocery store cart or basket.

Many golfers utilize a golf cart for transportation and golf bag storage while playing. A golf cart is an open air motor vehicle with seats located in a carriage. Golfers often sit inside the cart to rest after they have completed a hole of golf. While in the cart, uses take time to tally the numbers on the golf shots registered in the latest hole on a scorecard. Conventional golf carts include a scorecard holder that is present on the surface of the cart steering wheel. The holder secures a scorecard generally by way of a scorecard clip, whereby the scorecard is easily accessible and the user can utilize the flat surface of the steering wheel as a surface to write upon. While this assembly is useful for supporting the scorecard and for recording strokes, some golfers cannot easily visualize the scorecard without removing the same from its holder. This is particularly true for those with reduced vision or those not wearing their reading glasses while on the course.

The present invention relates to an adjustable magnifying viewer adapted for several applications, and in a preferred embodiment, for use in conjunction with a golf cart. The device comprises a magnifying viewer lens that is clamped onto the steering column of a golf cart. The assembly comprises an adjustable and extendable arm that attaches the magnifying viewer lens to the steering wheel via a series of clamps, whereby the viewer and the lens is positionable over the steering wheel in the traditional location in which a scorecard is generally maintained. The assembly secures to the steering wheel column of the vehicle and therefore turns with the steering wheel, while the viewer lens is positionable through the steering wheel and over its flat central portion.

In addition to be supportable by the steering column, it is contemplated that the magnifying viewer lens be detachable therefrom and held by hand or stowed independently from the arm assembly. Once removed, the assembly can be drawn closer to the user to view the scorecard therein, or alternatively the lens may be removable such that a user can inspect another object not held by the viewer housing. Finally, it is contemplated that the assembly be attachable to a grocery cart or grocery basket, providing a means to support a shopping list and allow a user to utilize the lens for inspecting labels and grocery items in the store.

In the preferred configuration, the assembly enables a user to view a golf scorecard throughout a round without needing to store or locate a pair of reading glasses amongst other golf gear. The preferred embodiment comprises an extendable arm with one or more ball joints and an extendable structure so as to support the magnifying viewer lens housing in a desired location. This allows the user to locate the lens and to customize the view of the scorecard to the strength needed for that individual user's eyesight. The magnification power of the lens is tailored to the strength required by the specific user, whereby the lens is interchangeable and removable. Overall, the assembly provides an improved viewer assembly for use in a golf cart.

2. Description of the Prior Art

Devices have been disclosed in the prior art that relate to magnifying lens and assemblies therefor. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

One such device of the prior art is U.S. Patent Publication No. 2011/0089211 to Heinl, which discloses a golfer's aid in the form of a magnified scorecard reader that uses a bracket, a magnifying lens, and a body portion that affixes directly to the steering wheel. The assembly comprises a body portion that affixes via fasteners to the steering wheel, while further providing locations in which to support items such as golf tees, a cigar, and other golf items. While providing a magnifying assembly for a golf cart, the Heinl device fails to anticipate the structure of the present invention, which secures to the steering column of the golf cart and supports a score card therein.

Another device is U.S. Pat. No. 5,847,883 to Rispoli, which discloses an adjustable magnifying device that comprises a magnifying surface supported by a member that connects along the surface edge and furthermore connects to one or more intermediate members. Each of the members includes a socket joint, while the lower end of the assembly secures to a clip or clamp member. While providing an adjustable magnifying surface, the Rispoli device fails to contemplate an assembly attachable to the steering column of a vehicle or the lens housing of the present invention.

U.S. Pat. No. 6,441,974 to Miranda discloses a magnifying device that is mountable to the handle of a shopping cart. The device comprises a magnifying device and a clamp for securing to a shopping cart. Similar to Rispoli and Heinl, the Miranda device fails to contemplate or disclose a structure suitable for attaching to the steering column of a golf cart, and furthermore fails to provide an articulating and adjustable assembly as provided herein.

Finally, U.S. Pat. No. 3,955,884 to Del Pesco, Sr. discloses a magnifying lens holder that includes a modular frame for supporting the magnifying lens in a number of different positions. The frame forms a clamp, a support for supporting the lens on a flat surface, and an assembly that can be used to clip the stowed lens to the belt of a user when the same is folded into the interior of the frame. While providing a unique frame that supports a magnifying lens, the Del Pesco, Sr. device similarly fails to disclose the novel aspects of the present invention, which is particularly suited for use with a golf cart and for attaching to a grocery cart.

Overall, the present invention provides an assembly that supports a magnifying viewer in connection with a golf cart steering column, and alternatively from the edge of a grocery cart or grocery basket. The assembly comprises one or more ball joints and an extendable structure such that the user can position a magnifying lens over an object to be viewed. The lens is removably supported within a housing and can be interchanged with different lens magnifications as required. The present invention provides a novel means of magnifying a score card on a golf cart or grocery items while in a grocery store.

It is submitted that the present invention is substantially divergent in design elements from the prior art, and consequently it is clear that there is a need in the art for an improvement to existing magnifying viewer devices. In this regard the instant invention substantially fulfills these needs.

### SUMMARY OF THE INVENTION

In view of the foregoing disadvantages inherent in the known types of magnifying viewer devices now present in the prior art, the present invention provides a new magnifying viewer and support assembly that can be utilized for providing convenience for the user when magnifying a golf scorecard or item in a grocery store.

It is therefore an object of the present invention to provide a new and improved magnifying viewer device that has all of the advantages of the prior art and none of the disadvantages.

It is another object of the present invention to provide a magnifying viewer device that is affixable to the steering column of a golf cart and supports a magnifying lens that is positionable over the steering wheel, upon which is generally positioned a scorecard.

Another object of the present invention is to provide a magnifying viewer device that supports a magnifying lens that can be removed and replaced to a magnification suitable for the user.

Yet another object of the present invention is to provide a magnifying viewer device that supports a magnifying lens in a housing, wherein some embodiments contemplate the housing being separable from its support such that the user can use the magnifying lens apart from the support assembly.

Another object of the present invention is to provide a magnifying viewer device that can attach to a portion of a grocery cart or basket in certain embodiments.

Another object of the present invention is to provide a magnifying viewer device that includes a support structure with at least one ball joint and an extendable structure, thereby positioning the magnifying lens in a desired location while in use.

A final object of the present invention is to provide a magnifying viewer device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of a first embodiment of the present invention, wherein the assembly attaches to the steering column of a golf cart.

FIG. 2 shows a side view of a second embodiment of the present invention, wherein the assembly pivotably attaches to the steering column of a golf cart.

FIG. 3 shows a view of a golf cart steering wheel and one location within which the magnifying lens may be placed while in use.

FIG. 4 shows a perspective view of the magnifying lens housing of the present invention.

FIG. 5 shows an overhead cross section view of the lens housing of the present invention.

FIG. 6 shows a frontal view of the lens housing of the present invention.

FIG. 7 shows a view of an alternate configuration of the present invention, wherein the lens housing is supported by an assembly affixable to a grocery cart or basket.

### DETAILED DESCRIPTION OF THE INVENTION

Reference is made herein to the attached drawings. Like reference numerals are used throughout the drawings to depict like or similar elements of the magnifying viewer device of the present invention. For the purposes of presenting a brief and clear description of the present invention, the preferred embodiment will be discussed as used for supporting a magnifying lens from a golf kart steering column or grocery store cart. The figures are intended for representative purposes only and should not be considered to be limiting in any respect.

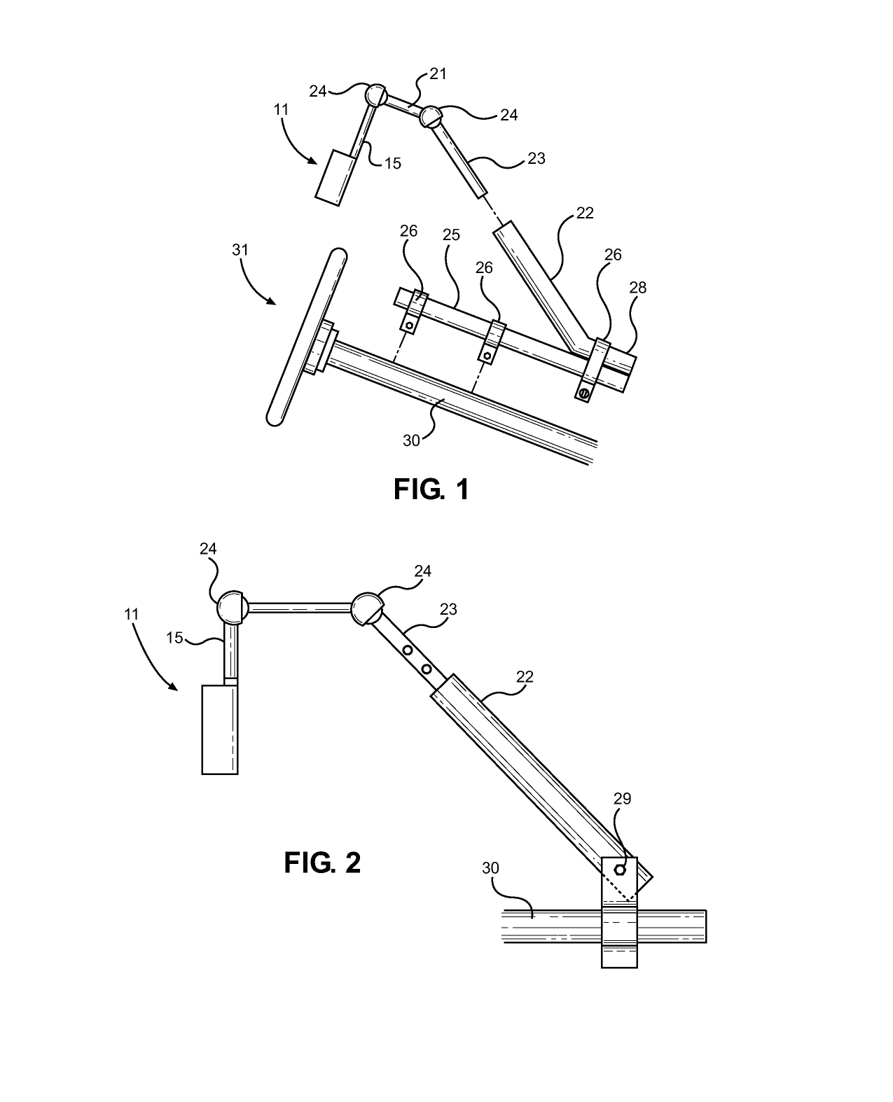

Referring now to FIG. 1, there is shown a side view of the magnifying viewer device of the present invention. The device comprises a magnification lens disposed within a lens housing 11, which is supported by a support assembly that comprises one of several embodiments. The first embodiment is shown in FIG. 1, which comprises an attachment assembly adapted to secure to the exposed steering column 30 of a golf cart. The support assembly comprises an elongated attachment rod 25 that is clamped to the steering column 30 via a plurality of clamps 26. Secured to the attachment rod 25 is an angled sleeve 22 that is similarly clamped to the attachment rod 25. The angled sleeve comprises an angled sleeve portion 22 and a straight portion 28 that aligns with the attachment rod 25. The sleeve portion 22 extends upward and away from the steering column 30, providing a tubular structure adapted to receive the telescoping portion 23 of the attachment assembly therein.

The telescoping portion 23 comprises an elongated member that is adapted to be slidably received by the sleeve portion 22. A locking pin or similar telescoping joint fastener is provided along the sleeve portion 22 to lock the telescoping portion 23 therein and in a static configuration with respect thereto. The lower end of the telescoping portion 23 is positioned within the sleeve portion 22, while the upper end thereof terminates at a first ball joint 24.

At least one ball joint 24 is disposed along the assembly for rotatably adjusting the position of the lens housing 11 with respect to the steering column 30. In the configuration as shown in FIG. 1, the assembly comprises a first and second ball joint 24 assembly, wherein the telescoping member 23 and an intermediate member 21 are rotatably joined, and furthermore the intermediate member 21 and the lens housing member 15 are rotatably joined. The lens housing member 15 is used to position the lens housing 11 along the central region of a golf cart steering wheel 31, while the intermediate member 21 is positioned over or through the steering wheel 31. Each of the ball joints is a spherical joint that allows rotation about its center point within a given range. The construction of this joint is a captive ball rotatably disposed within a socket, the socket secured to one member while the captive ball is affixed to another member.

Referring now to FIG. 2, there is shown a second configuration of the attachment assembly of the present invention. In this configuration, an additional pivot point is provided at the base of the sleeve portion 22. The sleeve portion 22 is pinned to the attachment rod 30 or directly to the steering column via a pin joint 29 disposed on an attachment clamp. The sleeve portion 22 therefor is rotatably attached to the steering column, which adds an additional degree of freedom to the assembly. The telescoping member 23 is slidably received by the sleeve portion 22 and at least one ball joint 24 is provided between the telescoping member 23 and the lens housing 11, which is supported by the elongated lens housing member 15.

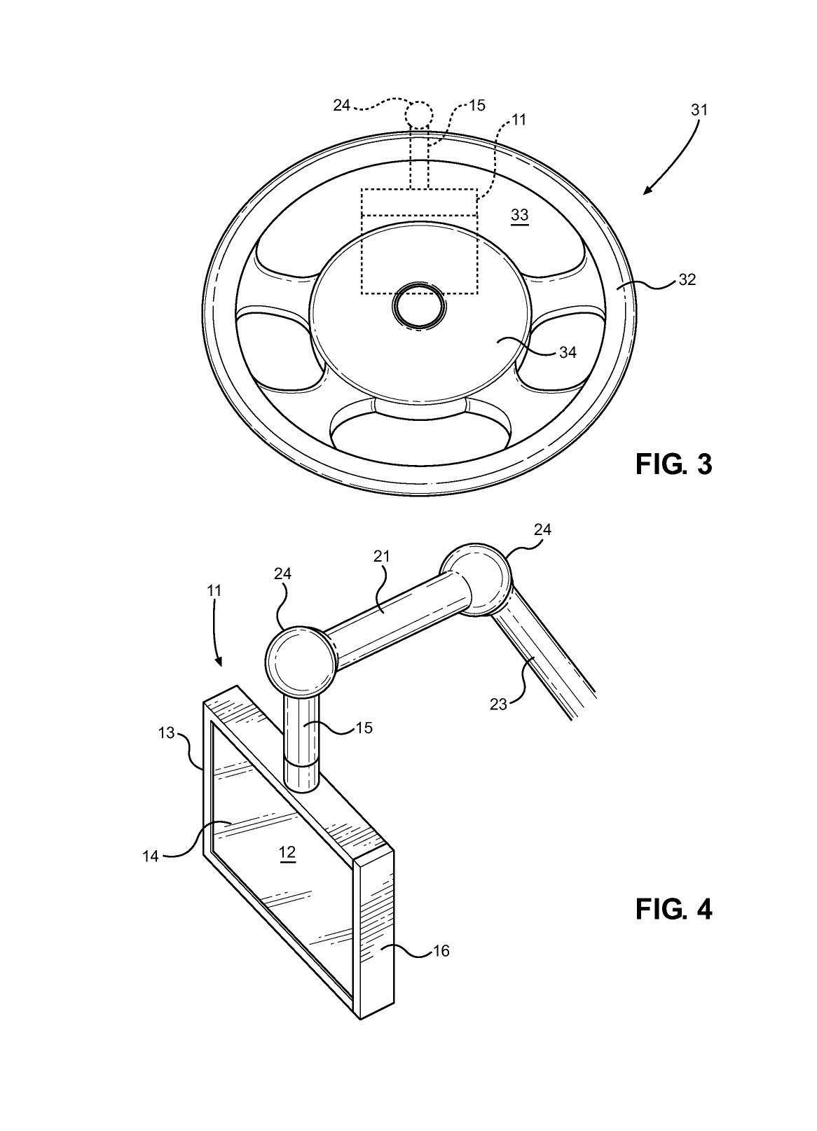

Referring now to FIG. 3, there is shown a frontal view of the steering wheel of a golf cart, which includes a central area 34 upon which is generally disposed a clip and a flat surface upon which to record strokes on a score card. The present invention contemplates a magnification lens disposed within a housing 11, wherein the housing 11 is positionable over or through the steering wheel rim 32. The user can look through the housing 11, which supports a magnification lens, whereby the scorecard image is enhanced and magnified for users with reduced visual acuity. As shown, the elongated lens housing member 15 can be placed over the outer rim 32 of the steering wheel or positioned through an interior gap 33 between the rim 32 and central portion 34. Since the housing 11 and its support assembly are attached to the steering column, the support assembly rotates therewith and will not clash with the steering wheel 31 as it rotates. The user positions the housing 11 in a desired location using the ball joints 24, telescoping member (FIGS. 1 & 2), and optional pivot joint (FIG. 2).

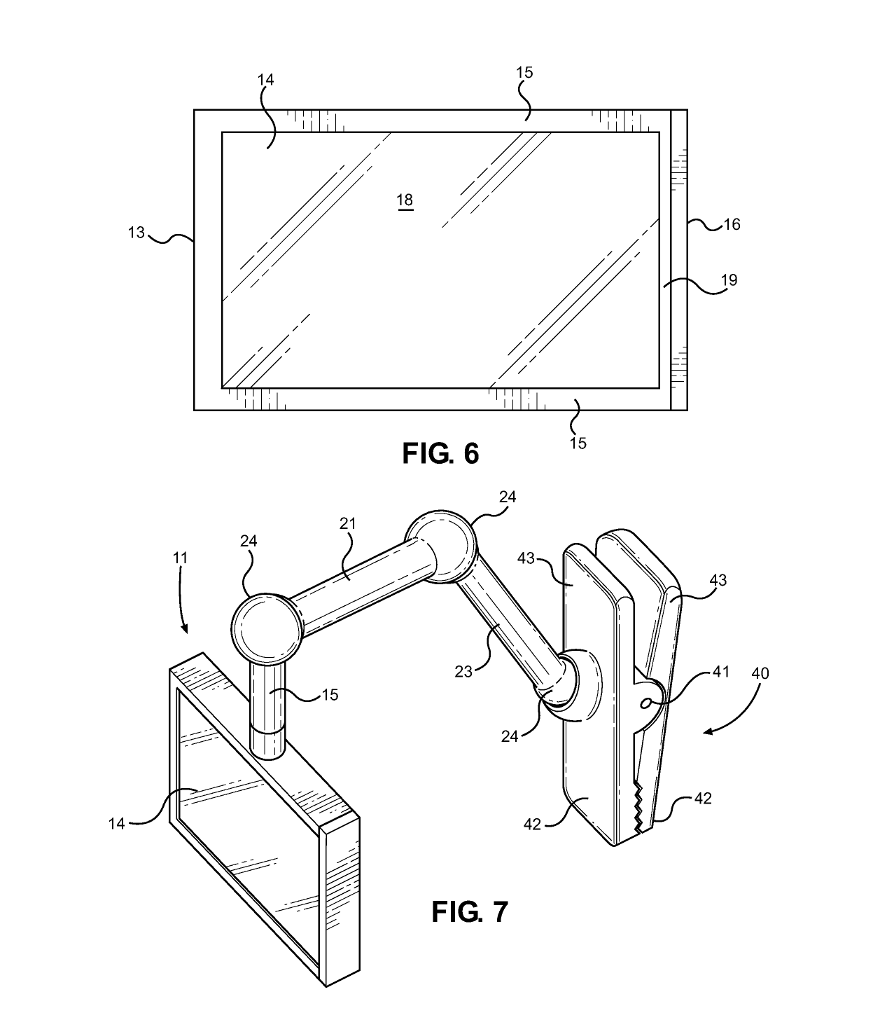

Referring now to FIGS. 4 and 6, there are shown close-up views of the lens housing 11 of the present invention. The lens housing 11 comprises a frame within a first sidewall 13, a second sidewall 16, and an upper and lower surface 15 forming a rectangular structure with an open interior 18. The front face 12 and rear face are open, whereby a magnification lens 14 is disposed with within the housing 11 for the user to view through. The elongated lens housing member 15 is preferably removably secured to the upper surface 15 of the housing 11, while one of the first and second sidewalls is pivotably attached to the housing to allow the interior thereof to be accessed. As shown in FIG. 4 and FIG. 6, the second sidewall 16 is one that can be pivoted away from the housing, revealing the lens 14 disposed within the housing interior 18 such that the lens 14 can be retrieved and replaced as desired. This allows the desired lens magnification to be used to suit the user's needs.

While in use, the user places the housing over a scorecard or similar item to be inspected, whereby the ball joints 24 and the arm members 21, 24 of the support assembly allow the user to update the positioning of the housing 11. The user can then look through the lens 14, which provides a magnified view of images and writing thereunder. It is contemplated that common, non-prescription power lenses may be deployed in the housing 11, or alternatively custom powered lens may be available. The goal is to provide an assembly that allows a golfer to play a round and record his or her score without retrieving reading glass upon when filling out a scorecard.

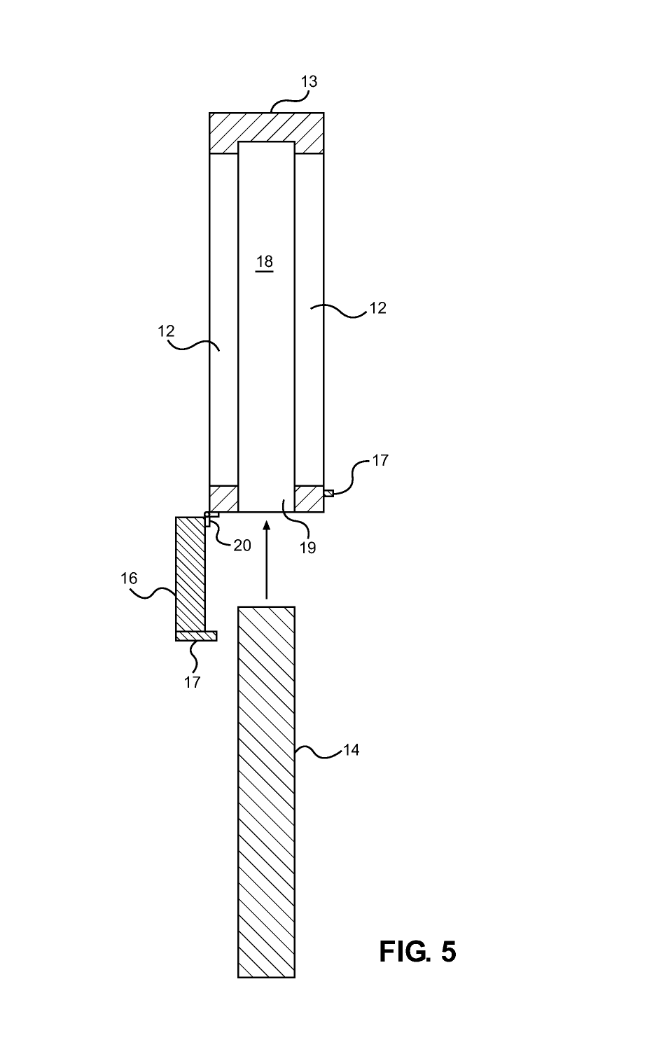

Referring now to FIG. 5, there is shown an overhead cross section view of the lens housing 11 of the present invention with its second sidewall 16 in an open state. The sidewall 16 is hingedly attached to the housing via a hinge join 20, which allows the sidewall 16 to be pivoted away from the housing to reveal its open interior 18. The sidewall 16 includes a clasp 17 or similar fastener/hardware article to secure the sidewall 16 in a closed state. Once opened, the open side 19 of the housing allows a lens 14 to be positioned therethrough and into the open interior 18 of the housing. The open front and rear surfaces 12 allow a user to view through the lens 14 once disposed therein. After being loaded, the lens 14 is retained within the housing via the closed first 13 and second 16 sidewall, and the upper and lower surfaces that form a picture frame around the perimeter of the lens 14.

Overall the present invention is designed for use on a golf course and in conjunction with the steering column of a golf cart. However, an additional embodiment is disclosed and shown in FIG. 7, which is primarily adapted for use in a grocery store or similar consumer environment. In this embodiment, the lens housing 11 is supported by a support assembly that terminates at an alligator clip 40 at one end and provides one or more ball joints 24 therebetween for positioning. The alligator clip assembly 40 comprises a first and second clip member that are pinned together at a pin joint 41 and biased towards each other via a coil spring (not shown). The clamping end 42 of each clip member is biased together while the outer ends 43 thereof are biased away from one another. This arrangement and structure is well understood in the art of clip fasteners.

Between the alligator clip assembly 40 and the lens housing 11 is at least one elongated intermediate member 23, 21, at least one ball joint 24, and a removable connection between the lens housing 11 and the intermediate members. The ball joints 24 allow the clip 40 and lens housing 11 to be oriented in a preferred arrangement relative to one another, while the removable connection allows the lens housing 11 to be used on its own within a store. This allows a user to inspect a grocery list while attached, and to inspect individual items and labels within the store using the housing 11 alone. The clip assembly 40 is ideally used to secure the assembly to a grocery cart or grocery basket. As with the golf embodiment, this embodiment allows one to shop and view a list of items without donning reading glasses.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. The structure of the housing 11 and the support assembly share the same construction between both embodiments.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A magnification viewer lens device, comprising:
a lens housing comprising one or more sidewalls, an interior volume, an open front surface and rear surface, and a magnification lens disposed within said interior volume;
a support assembly affixed to said lens housing comprising one or more intermediate members, one or more ball joints, and a telescoping member in telescopic relationship with a sleeve portion;
one or more clamps adapted to secure said sleeve portion to an exposed steering wheel column of a vehicle such that said support assembly rotates within said steering wheel column;
said support assembly sized to allow positioning of said lens housing over a steering wheel attached to said steering wheel column when said support assembly is secured to said steering column.

2) The magnification viewer lens device of claim 1, wherein:
said sleeve portion comprises an angled sleeve portion and a straight portion;
said straight portion adapted to be aligned with said steering column and said angled sleeve portion extending upward and away from said steering column;
said one or more clamps securing said straight portion to said steering column.

3) The magnification viewer lens device of claim 1, wherein:
said one or more clamps secure said sleeve portion to an attachment rod;
said attachment rod being aligned with said steering column and secured thereto by one or more clamps.

4) The magnification viewer lens device of claim 1, wherein:
said sleeve portion is pivotably attached to a first clamp at a pin joint;
said first clamp securing said sleeve portion to said steering column.

5) The magnification viewer lens device of claim 1, wherein:
said sleeve portion is pivotably attached to a first clamp at a pin joint;
said first clamp securing said sleeve portion to an attachment rod;
said attachment rod being aligned with said steering column and secured thereto by one or more clamps.

6) The magnification viewer lens device of claim 1, wherein said support assembly further comprises:
an elongated lens housing member, a first intermediate member, and said telescoping member;
a first ball joint between said lens housing member and said first intermediate member;
a second ball joint between said first intermediate member and said telescoping member.

7) The magnification viewer lens device of claim 1, wherein said lens housing is removably attached to said support assembly.

8) The magnification viewer lens device of claim 1, wherein:
said magnification lens is removable from said lens housing;
at least one of said sidewalls of said lens housing being movable with respect to said lens housing, whereby an edge of said magnification lens is accessible to replace the same.

9) A magnification viewer lens device, comprising:
a lens housing comprising one or more sidewalls, an interior volume, an open front surface and rear surface, and a magnification lens disposed within said interior volume;
a support assembly affixed to said lens housing comprising one or more intermediate members and one or more ball joints;
said support assembly connected to an alligator clip assembly, said alligator clip assembly comprising a first and second clip member pinned together, said first and second clip member each having a clamping end and an outer end, a spring biasing each clamping end together and biasing each outer end away from one another;
said alligator clip assembly sized to secure to an exposed portion of a grocery cart or grocery basket and support said support assembly and lens housing therefrom.

10) The magnification viewer lens device of claim 9, wherein at least one of said one or more intermediate members further comprising a telescoping member in telescopic relationship with a sleeve portion.

11) The magnification viewer lens device of claim 9, wherein said support assembly further comprises:
an elongated lens housing member, a first intermediate member, and a second intermediate member;
a first ball joint between said lens housing member and said first intermediate member;
a second ball joint between said first intermediate member and said second intermediate member.

12) The magnification viewer lens device of claim 9, wherein said support assembly further comprises:
an elongated lens housing member, a first intermediate member, and a second intermediate member;
a first ball joint between said lens housing member and said first intermediate member;
a second ball joint between said first intermediate member and said second intermediate member.

13) The magnification viewer lens device of claim 9, wherein said lens housing is removably attached to said support assembly.

14) The magnification viewer lens device of claim 9, wherein:
said magnification lens is removable from said lens housing;
at least one of said sidewalls of said lens housing being movable with respect to said lens housing, whereby an edge of said magnification lens is accessible to replace the same.
